(19) United States
(12) Patent Application Publication
(10) Pub. No.: US 2003/0080564 A1
(43) Pub. Date: May 1, 2003

(54) Pipe joint assembly and method for assembling the same

(76) Inventors: Ryoichi Izumi, Okazaki-city (JP); Takeshi Hishikawa, Anjo-city (JP)

Correspondence Address: HARNESS, DICKEY & PIERCE, P.L.C., P.O. BOX 828, BLOOMFIELD HILLS, MI, 48303, US

(21) Appl. No.: 10/280,751

(22) Filed: Oct. 25, 2002

(30) Foreign Application Priority Data
Oct. 25, 2001 (JP) 2001-327686

(51) Int. Cl. F16L 13/14; F16L 19/04; F16L 19/08

(52) U.S. Cl. 285/382

(57) ABSTRACT

An annular claw, which extends outwardly from a joint block, is crimped over a flange of each pipe, so that engaging recesses of the joint block are engaged with the flange of the pipe, and thus each of the engaging recesses deforms and interlocks with a corresponding opposed portion of the flange of the pipe. As a result, rotation of the pipe relative to the joint block is effectively restrained.

### CROSS REFERENCE TO RELATED APPLICATION

This application is based on and incorporates herein by reference Japanese Patent Application No. 2001-327686 filed on Oct. 25, 2001.

### BACKGROUND OF THE INVENTION

1. Field of the Invention

The present invention relates to an improvement of a pipe joint assembly, which couples pipes through a crimping or staking process and is suitable, for example, for coupling refrigerant pipes of a refrigeration cycle of an air-conditioning system, and also relates to a method for assembling such an pipe joint assembly.

2. Description of Related Art

FIGS. 18A to 19 show a pipe joint assembly or structure disclosed in Japanese unexamined patent publication No. H5-141580. A flange (radial projection) 118, which protrudes radially outwardly from a pipe 112, is formed through bulging, and a plurality of projections 118a are formed on one side of the flange 118, which is engaged with a claw 116 of a joint block (connector member) 110. The pipe 112 is connected to the joint block 110 as follows. That is, a distal end of the pipe 112 is inserted into a fluid passage 111 of the joint block 110, so that the flange 118 abuts against an abutting surface 120 of the joint block 110, which is located radially inward of the claw 116, and thus the pipe 112 is positioned at a predetermined position relative to the joint block 110. Then, the claw 116 of the joint block 110 is bent and crimped over the flange 118 of the pipe 112 to secure the distal end of the pipe 112 to the joint block 110.

When the claw 16 is bent and crimped over the flange 118, recesses 116a are formed in the claw 116 by the corresponding projections 118a of the flange 118, so that engaged points, at each of which one recess 116a and the corresponding projection 118a are engaged each other, are arranged in a circumferential direction of the flange 118 to provide a securing force for restraining rotation of the pipe 112.

In the pipe joint assembly, an aluminum alloy having a relatively low hardness, such as aluminum A3003, may be selected as a metal material of the pipe 112. Since components, such as a refrigerant pressure switch, a sight glass and a refrigerant-filling valve, need to be installed to the joint block 110, an aluminum alloy having a relatively high mechanical strength and a relatively high hardness, such as aluminum A6061, may be selected as a metal material of the joint block 110.

Thus, when the claw 116 is bent and crimped over the flange 118, the hard claw 116 compresses and deforms the projections 118a of the flange 118, so that the flange 118 is brought into surface engagement with the claw 116. This surface engagement results in insufficient securing force for restraining rotation of the pipe 112.

### SUMMARY OF THE INVENTION

The present invention addresses the above disadvantage. Thus, it is an objective of the present invention to provide a pipe joint assembly, which includes at least one pipe and a joint block and provides an improved securing force for restraining rotation of each pipe relative to the joint block even when the joint block has a hardness higher than that of each pipe. It is another objective of the present invention to provide a method for assembling such a pipe joint assembly.

To achieve the objectives of the present invention, there is provided a pipe joint assembly, which includes at least one pipe and a joint block. Each pipe includes a radial projection that projects radially outwardly. The joint block has a hardness greater than that of the at least one pipe. The joint block includes a flow passage, at least one pipe-receiving opening, at least one crimpable segment and at least one pipe-engaging surface. The flow passage extends in the joint block. Each pipe-receiving opening is communicated with the flow passage and receives a corresponding one of the at least one pipe. Each crimpable segment is integrally formed in the joint block at a corresponding one of the at least one pipe-receiving opening and is crimpable over the radial projection of the corresponding pipe to secure the corresponding pipe relative to the joint block when the corresponding pipe is received in the corresponding pipe-receiving opening. Each pipe-engaging surface is positioned adjacent to a corresponding one of the at least one pipe-receiving opening and is engageable with the radial projection of a corresponding one of the at least one pipe. Each of the at least one pipe-engaging surface includes at least one of at least one engaging recess and at least one engaging protrusion. Each engaging recess is engageable with the radial projection of the corresponding pipe to deform and receive a corresponding opposed portion of the radial projection of the corresponding pipe to interlock with the corresponding opposed portion of the radial projection when the corresponding crimpable segment is crimped over the radial projection of the corresponding pipe. Each engaging protrusion is engageable with the radial projection of the corresponding pipe to deform and bite into a corresponding opposed portion of the radial projection of the corresponding pipe to interlock with the corresponding opposed portion of the radial projection when the corresponding crimpable segment is crimped over the radial projection of the corresponding pipe.

To achieve the objectives of the present invention, there is also provided a method for assembling a pipe joint assembly, which includes at least one pipe and a joint block. First, each pipe is inserted into a corresponding pipe-receiving opening of the joint block. Then, a crimpable segment of the joint block is crimped over a radial projection of the pipe such that at least one pipe-engaging surface of the joint block, each of which includes at least one of at least one engaging recess and at least one engaging protrusion, is engaged with the radial projection of the pipe, and thus the at least one of the at least one engaging recess and the at least one engaging protrusion of each of the at least one pipe-engaging surface deforms and interlocks with a corresponding opposed portion of the radial projection of the pipe.

### BRIEF DESCRIPTION OF THE DRAWINGS

The invention, together with additional objects, features and advantages thereof, will be best understood from the following description, the appended claims and the accompanying drawings in which:

FIG. 1 is a front view of a pipe joint assembly in a non-assembled state according to a first embodiment of the present invention;

FIG. 2 is a longitudinal cross-sectional view of the pipe joint assembly of FIG. 1;

FIG. 3 is a cross sectional view of the pipe joint assembly in an assembled state according to the first embodiment;

FIG. 4A is an enlarged partial longitudinal cross-sectional view of a joint block according to the first embodiment;

FIG. 4B is an end view of the joint block of FIG. 4A;

FIG. 5 is an enlarged partial longitudinal cross-sectional view of the pipe joint assembly in the assembled state according to the first embodiment of the present invention;

FIG. 6 is an enlarged partial longitudinal cross-sectional view of a joint block according to a second embodiment of the present invention;

FIG. 7 is a partial longitudinal cross-sectional view of a pipe joint assembly in an assembled state according to the second embodiment of the present invention;

FIG. 8A is an enlarged partial longitudinal cross-sectional view of a joint block according to a third embodiment of the present invention;

FIG. 8B is an end view of the joint block of FIG. 8A;

FIG. 9 is a partial longitudinal cross-sectional view of a pipe joint assembly in an assembled state according to the third embodiment of the present invention;

FIG. 10A is an enlarged partial longitudinal cross-sectional view of a joint block according to a fourth embodiment of the present invention;

FIG. 10B is an end view of the joint block of FIG. 10A;

FIG. 11 is a partial longitudinal cross-sectional view of a pipe joint assembly in an assembled state according to the fourth embodiment;

FIG. 12A is an enlarged partial longitudinal cross-sectional view of a joint block according to a fifth embodiment of the present invention;

FIG. 12B is an end view of the joint block of FIG. 12A;

FIG. 13 is a partial longitudinal cross-sectional view of a pipe joint assembly in an assembled state according to the fifth embodiment;

FIG. 14A is an enlarged partial longitudinal cross-sectional view of a joint block according to a sixth embodiment of the present invention;

FIG. 14B is an end view of the joint block of FIG. 14A;

FIG. 15 is a partial longitudinal cross-sectional view of a pipe joint assembly in an assembled state according to the fifth embodiment;

FIG. 16A is an enlarged partial longitudinal cross-sectional view showing a modification of the joint block according to the first embodiment depicted in FIGS. 4A and 4B;

FIG. 16B is an end view showing the modification of the joint block according to the first embodiment depicted in FIGS. 4A and 4B;

FIG. 17A is an enlarged partial longitudinal cross-sectional view showing a modification of the joint block according to the fifth embodiment depicted in FIGS. 12A and 12B;

FIG. 17B is an end view showing the modification of the joint block according to the fifth embodiment depicted in FIGS. 12A and 12B;

FIG. 18A is a partial longitudinal cross-sectional view of a previously proposed joint block;

FIG. 18B is a partial longitudinal cross-sectional view of a previously proposed pipe;

FIG. 18C is an end view of the previously proposed pipe; and

FIG. 19 is an enlarged partial longitudinal cross-sectional view of a previously proposed pipe joint assembly in an assembled state.

### DETAILED DESCRIPTION OF THE INVENTION

Various embodiments of the present invention will be described with reference to the accompanying drawings.

(First Embodiment)

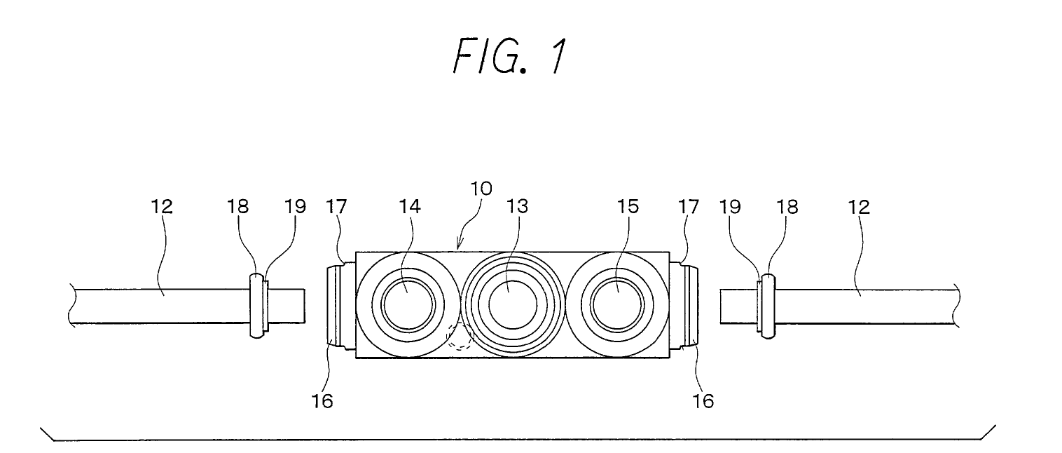

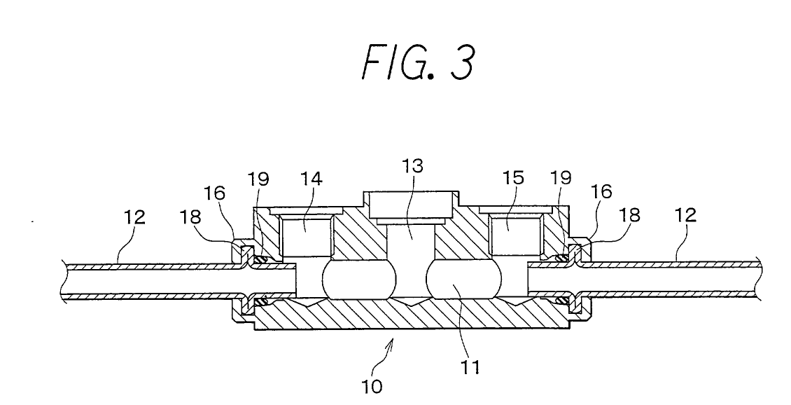

A pipe joint assembly according to a first embodiment of the present invention will be described with reference to FIGS. 1-5. The pipe joint assembly of the first embodiment is installed, for example, in a high pressure refrigerant pipe line on an outlet side of a condenser in a refrigeration cycle of a vehicle air conditioning system.

In the pipe joint assembly of the present embodiment, a joint block 10 servers as a pipe coupling member for coupling a couple of pipes 12. The joint block 10 has a rectangular parallelepiped shape and includes a fluid passage 11, which extends in the joint block 10 in a longitudinal direction of the joint block 10 and is communicated with pipe-receiving openings 30 located at opposed ends of the joint block 10. A distal end of each pipe 12 is secured to a corresponding one of the pipe-receiving openings 30 of the joint block 10 through a crimping or staking process. Specifically, the joint block 10 has three attachment holes 13-15, which are arranged along the longitudinal direction of the joint block 10. The attachment holes 13-15 are communicated with the fluid passage 11.

The attachment hole 13 arranged at the center is used to attach a sight glass (not shown) for checking a quantity of refrigerant being filled in the cycle. One of the attachment holes 14, 15 located next to the attachment hole 13 is used to attach a refrigerant pressure switch (not shown) for measuring a refrigerant pressure (high pressure), and the other one of the attachment holes 14, 15 is used to attach a refrigerant-filling valve (not shown), through which the refrigerant is filled in the cycle.

Each pipe 12 is made of an aluminum alloy having a relatively low hardness, such as aluminum A3003, to allow easy forming of the pipe 12. On the other hand, since the sight glass, the refrigerant pressure switch and the refrigerant-filling valve need to be installed to the joint block 10, the joint block 10 is made of an aluminum alloy having a relatively high mechanical strength and a relatively high hardness, such as aluminum A6061. That is, the joint block 10 has the hardness greater than that of the pipe 12.

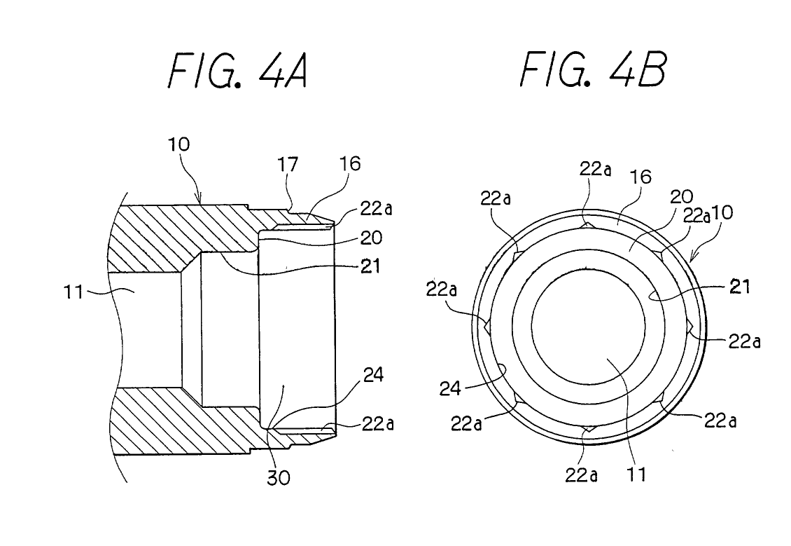

An annular claw (crimpable segment) 16, which is crimped over the corresponding pipe 12, extends in the longitudinal direction from an outer peripheral edge of each pipe-receiving opening 30. As shown in FIGS. 4A and 4B, the claw 16 is annular and has a relatively small wall thickness. Furthermore, the claw 16 has a wall-thickness reducing portion (step) 17, at which the wall thickness of the claw 16 is progressively reduced along an arc on an outer peripheral surface of the claw 16 at a base side of the claw 16. The claw 16 can be relatively easily deformed in a radially inward direction about the wall-thickness reducing portion 17.

Each pipe 12 has a flange (radial projection) 18, which is spaced a predetermined distance from the distal end of the pipe 12 and extends radially outwardly. The flange 18 extends continuously in a circumferential direction of the pipe 12 and is integrally formed in the pipe 12 by bulging. An O-ring (serving as a resilient sealing member) 19, which is made of a resilient material, such as a rubber material, is fitted around the pipe 12 on a distal side of the flange 18.

The joint block 10 has abutting surfaces (pipe-engaging surfaces) 20, each of which is located radially inward of the corresponding claw 16 to abut against the flange 18 of the corresponding pipe 12. The pipe 12 is positioned at a predetermined position relative to the joint block 10 when the flange 18 of pipe 12 abuts against the corresponding abutting surface 20 of the joint block 10. The joint block 10 also includes O-ring engaging surfaces 21, each of which is located radially inward of the corresponding abutting surface 20 and engages with the corresponding O-ring 19.

Each claw 16 of the joint block 10 includes engaging recesses 22a located on an inner surface of the claw 16, which is engaged with the flange 18 of the pipe 12. Each recess 22a is constructed such that when the claw 16 is crimped over the flange 18, a portion of the flange 18, which is opposed to the recess 22a, is deformed and is received into the recess 22a. Each recess 22a is formed in an inner circumferential surface (pipe-engaging surface) 24 of the annular claw 16 and extends in the longitudinal direction of the joint block 10, or in a direction generally parallel to the axial direction of the corresponding pipe-receiving opening 30. In the present embodiment, eight recesses 22a are circumferentially arranged at 45 degree intervals, and each recess 22a has a triangular or V-shaped cross section, as shown in FIG. 4B. It should be noted that FIG. 4A shows only two of the eight recesses 22a for the sake of simplicity. The recesses 22a are produced through cutting, plastic deformation or the like of the claw 16.

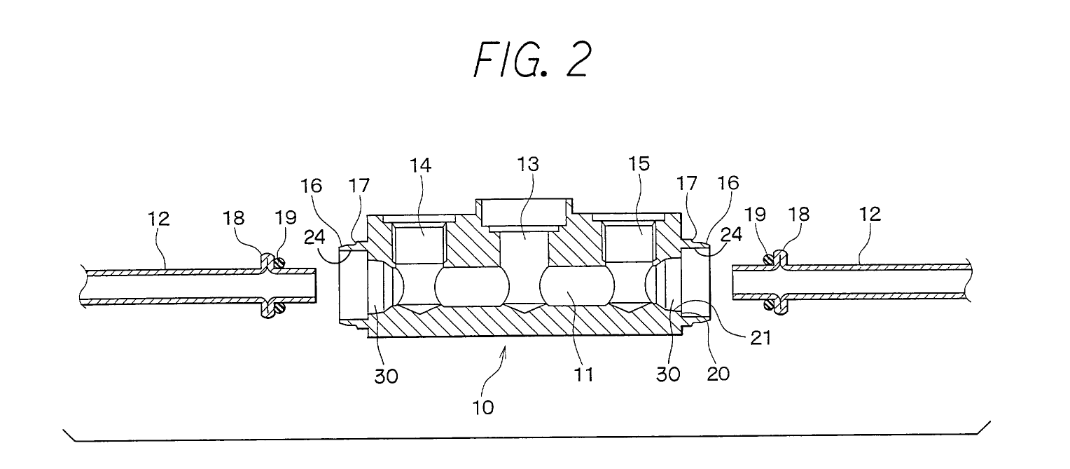

A way of assembling the pipe joint assembly will be described. The pipes 12 and the joint block 10 are not coupled in FIGS. 1 and 2. From this state, the distal end of each pipe 12 is inserted into the corresponding one of the pipe-receiving openings 30 of the joint block 10, so that the flange 18 of each pipe 12 is received in the corresponding annular claw 16 and abuts against the abutting surface 20 of the joint block 10. Thus, the pipes 12 are positioned relative to the joint block 10.

Thereafter, a pressing force is radially, inwardly applied to each annular claw 16 from a pressing member of a crimping machine (not shown), so that each claw 16 is bent and is crimped over the corresponding flange 18, resulting in securing of each claw 16 over the corresponding flange 18. The claw 16 is bent about the wall-thickness reducing portion 17.

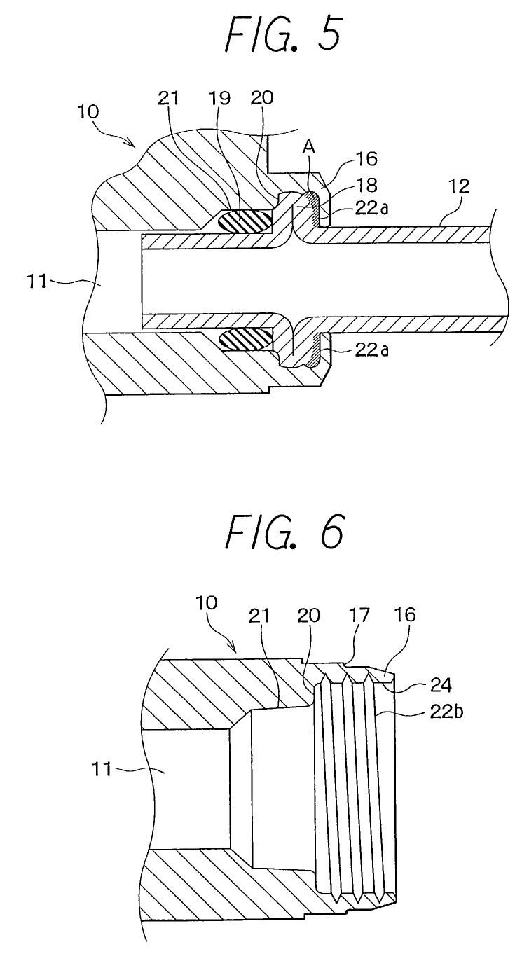

Since each pipe 12 is made of the aluminum alloy having the relatively low hardness, which is lower than that of the joint block 10, the portion of the flange 18, which is opposed to the corresponding recess 22a, is deformed to protrude into the recess 22a to interlock therewith by the pressing force exerted from the pressing member of the crimping machine. FIG. 5 shows the state of one claw 16 after the crimping process of the claw 16, and each shaded region A shows the protruded portion of the flange 18, which has been protruded or received into the corresponding recess 22a of the claw 16.

As described above, when each claw 16 of the joint block 10 is crimped over the flange 18 of the corresponding pipe 12, the protruded portions A are formed and are arranged in the circumferential direction. The protruded portions A serve as engaging portions or interlocked portions and provide an increased securing force for restraining rotation of the corresponding pipe 12

(Second Embodiment)

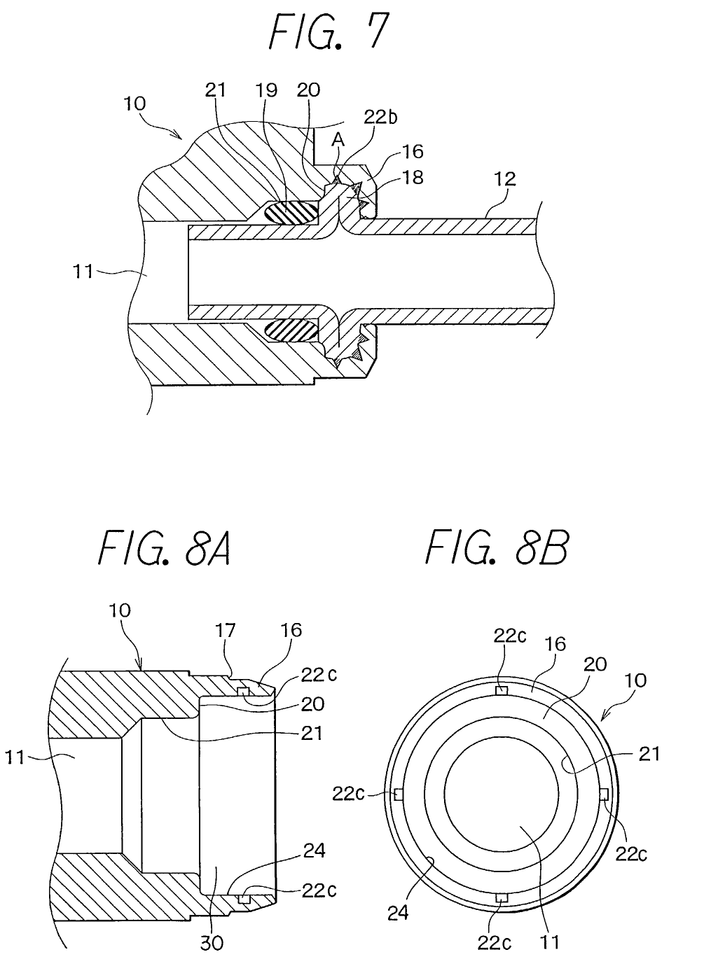

In the first embodiment, the recesses 22a, each of which extends in the longitudinal direction of the joint block 10, are formed in the inner circumferential surface 24 of the corresponding claw 16. In the second embodiment, as shown in FIGS. 6 and 7, a recess 22b in a form of a helical groove extends helically in the inner circumferential surface 24 of each annular claw 16.

Even with the recess 22b in the form of the helical groove, when the claw 16 is crimped over the corresponding flange 18, a portion of the flange 18, which is opposed to the recess 22b, is deformed to protrude into the recess 22b, as indicated by a shaded region A in FIG. 7. Thus, similar to the first embodiment, the securing force for restraining rotation of each pipe 12 can be advantageously improved.

(Third Embodiment)

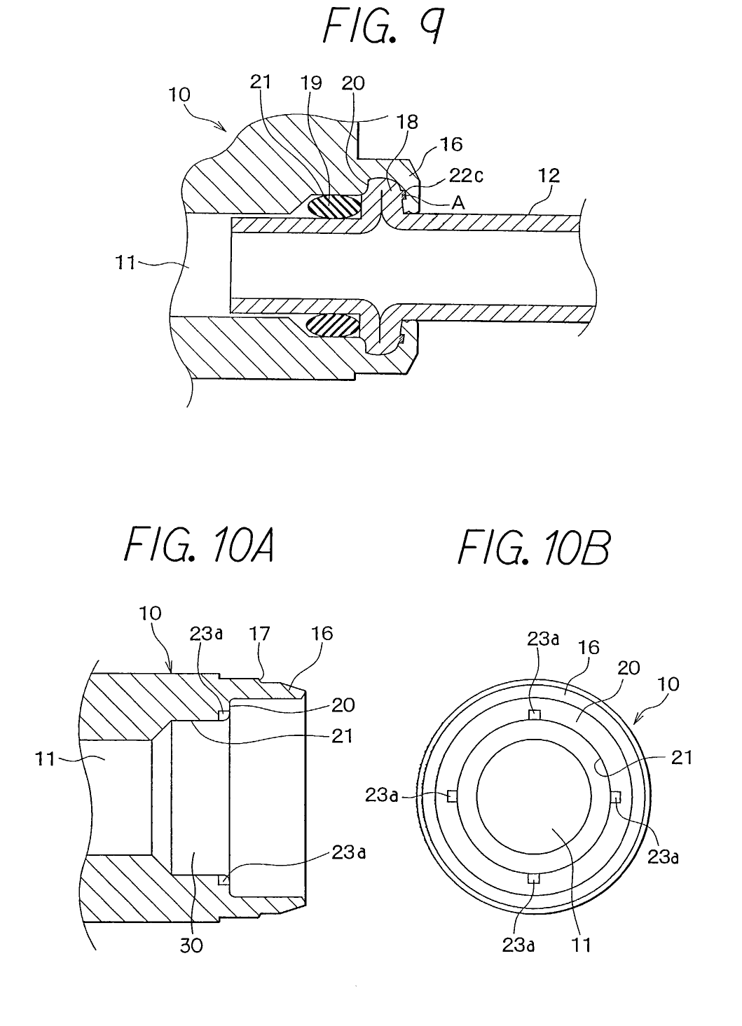

In the first embodiment, the recesses 22a, each of which extends in the longitudinal direction of the joint block 10, are formed in the inner circumferential surface 24 of the corresponding annular claw 16. In the third embodiment, as shown in FIGS. 8A to 9, there is provided a plurality of recesses 22c, each of which is shaped as a rectangular recess spotted and located at the axial intermediate point in the inner circumferential surface 24 of the corresponding annular claw 16. The recesses (the number of the recesses is four in the case of FIGS. 8A and 8B) 22c are arranged in the circumferential direction at generally equal intervals.

Even with the recesses 22c, each of which is shaped as the rectangular recess, when the claw 16 is crimped over the corresponding flange 18, a portion of the flange 18, which is opposed to the corresponding recess 22c, is deformed to protrude into the corresponding recess 22c, as indicated by a shaded region A in FIG. 9. Thus, the securing force for restraining rotation of each pipe 12 can be advantageously improved. It should be noted that the shape of each recess 22c is not limited to the rectangular recess and can be, for example, any other polygonal recess, a circular recess, an ellipsoidal recess or the like.

(Fourth Embodiment)

In each of the first to third embodiments, the portion of the flange 18 is deformed to protrude into the corresponding recess 22a-22c, which is formed in the inner circumferential surface 24 of the annular claw 16. In the fourth embodiment, as shown in FIGS. 10A to 11, there is provided a plurality of recesses 23a, each of which is spotted and located in the abutting surface 20 that is the end surface of the joint block 10 located radially inward of the annular claw 16.

Specifically, the recesses 23a are circumferentially arranged at predetermined intervals along an inner circumferential edge of the abutting surface 20, and each recess 23a is shaped as a rectangular recess for receiving corresponding protruded portion of the flange 18. In the case of FIG. 10B, four recesses 23a are arranged at 90 degree intervals.

When the annular claw 16 is crimped over the flange 18, a pressing force applied to claw 16 causes the flange 18 to be pressed between the claw 16 and the abutting surface 20, so that corresponding portion of the flange 18 is deformed to protrude into the corresponding recess 23a provided in the abutting surface 20 (as indicated by a shaded region A in FIG. 11). Thus, the securing force for restraining rotation of each pipe 12 can be advantageously improved.

(Fifth Embodiment)

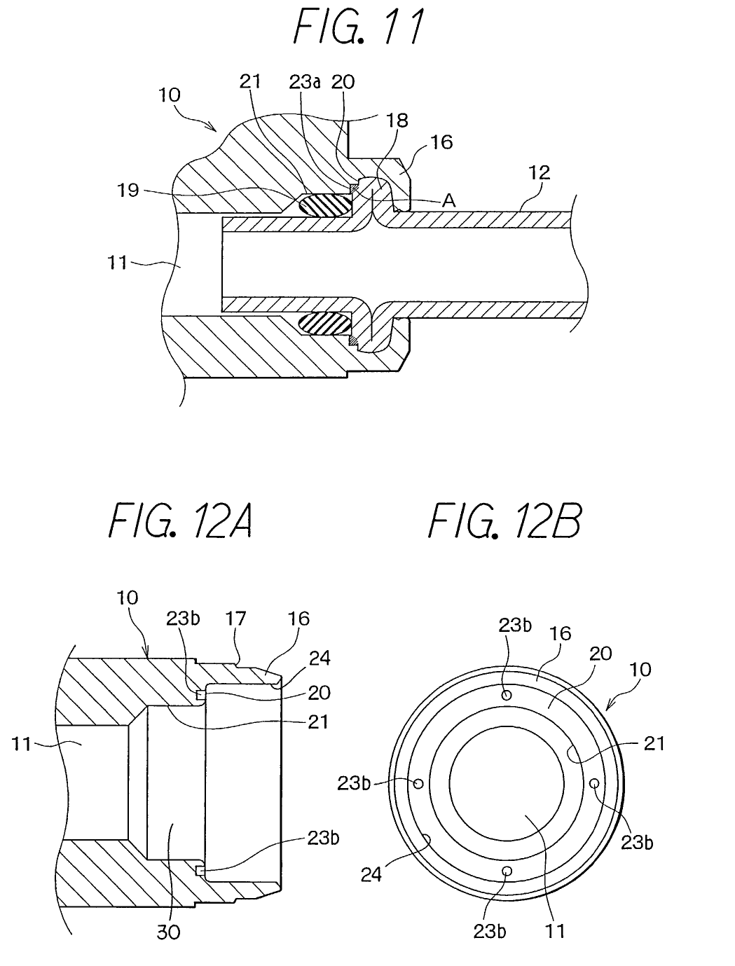

A fifth embodiment is a modification of the fourth embodiment. As shown in FIGS. 12 and 13, there is provided a plurality of circular recesses (in the case of FIGS. 12A to 13, a number of the recesses 23b is four) 23b, each of which is located at a radially intermediate point in the abutting surface 20 of the joint block 10 for receiving corresponding protruded portion of the flange 18.

It should be noted that each recess 23b of the fourth embodiment can be shaped as a circular recess, and each recess 23b of the fifth embodiment can be shaped as a rectangular recess. Furthermore, each recess of the fourth embodiment or fifth embodiment can be shaped into any polygonal recess.

(Sixth Embodiment)

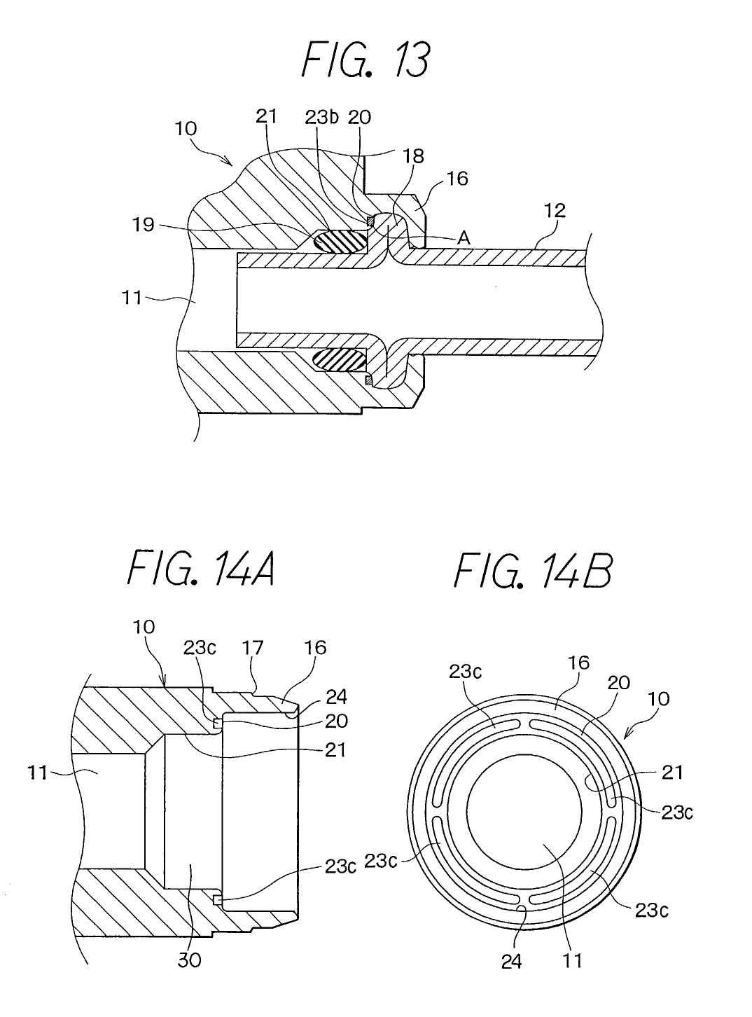

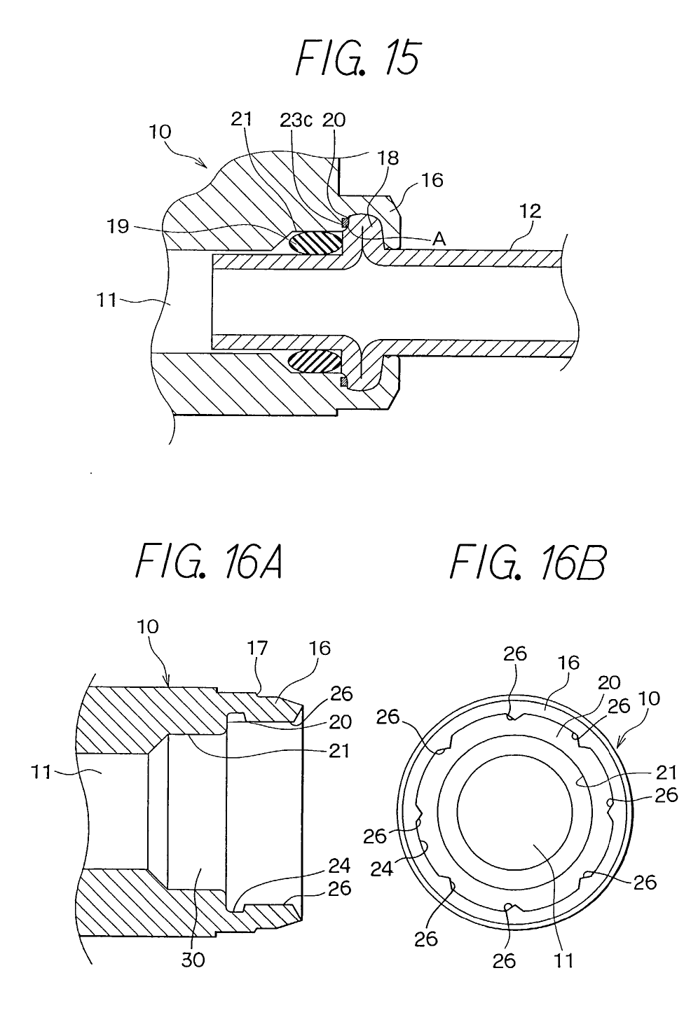

A sixth embodiment is a modification of the fourth or fifth embodiment. As shown in FIGS. 14 and 15, there is provided a plurality of arcuate recesses (in the case of FIGS. 14A to 15, a number of the recesses is four) 23c, each of which is located in the abutting surface 20 of the joint block 10 for receiving corresponding protruded portion of the flange 18.

(Other Embodiments)

The present invention is not limited to the above embodiments and can be modified as follows.

(1) The number of the recesses 22a-22c, 23a-23c in each of the first embodiment (FIGS. 1 to 5), the third embodiment (FIGS. 8A to 9) and the fourth embodiment (FIGS. 10A to 11) can be varied to any number. For example, it is possible to provide only one recess 22a, 22c, 23a-23c in each of the above embodiments.

(2) The recesses 22a-22c formed in the inner circumferential surface 24 of the annular claw 16 in any of the first to third embodiments can be provided together with the recesses 23a formed in the abutting surface 20 in the fourth embodiment. With this arrangement, the securing force for restraining rotation of each pipe 12 can be further improved.

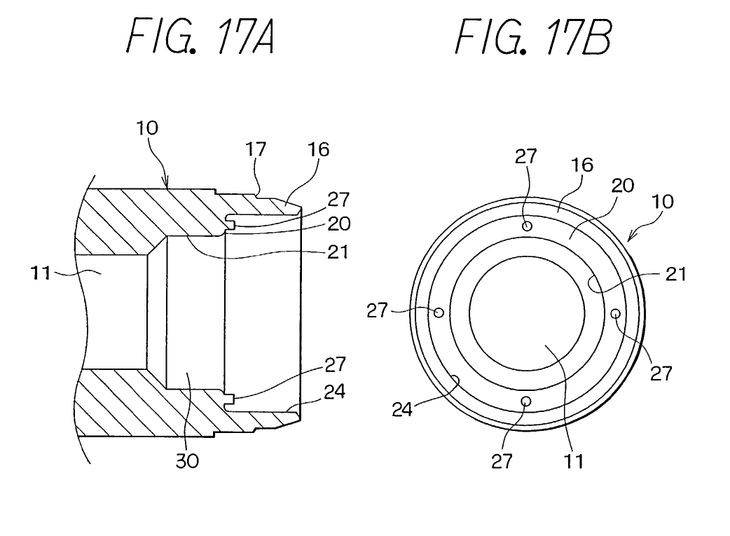

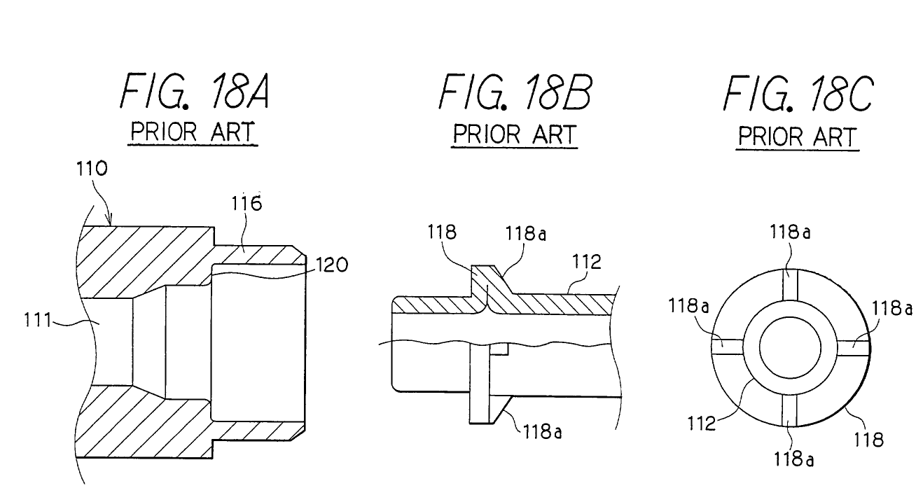

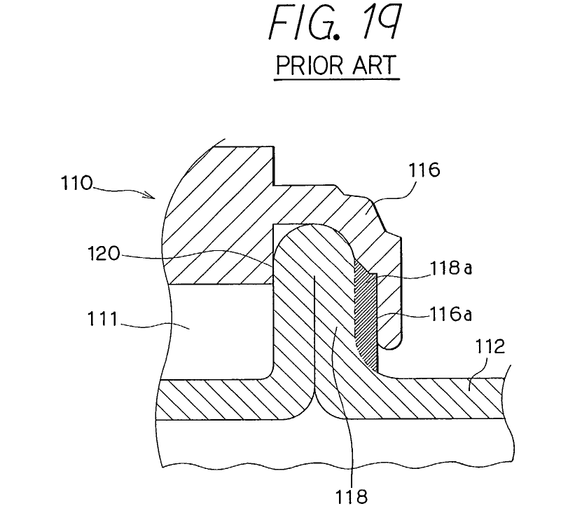

(3) In each of the first to fourth embodiments, the recesses 22a-22c, 23a-23c are formed in the joint block 10 made of the material having the relatively high hardness that is higher than that of each pipe 12. When each claw 16 is crimped over the flange 18 of the corresponding pipe 12, the corresponding portion of the flange 18 is forced to protrude into each opposed recess 22a-22c, 23a-23c of the joint block 10. Alternative to the recesses 22a-22c, 23a-23c, engaging protrusions may be formed in the joint block 10 such that the protrusions are deformed to bite into the flange 18 when the claw 16 is crimped over the flange 18 of the corresponding pipe 12. For example, the recesses 22a of the first embodiment shown in FIGS. 4A to 5 can be replaced with protrusions 26 shown in FIGS. 16A and 16B. Also, the recesses 23a of the fifth embodiment shown in FIGS. 12A to 13 can be replaced with protrusions 27 shown in FIGS. 17A and 17B.

Even with such a modification, the engaged portions are formed between the protrusions of the joint block 10 and the flange 18 of the corresponding pipe 12, so that the securing force for restraining rotation of each pipe 12 can be advantageously improved.

In each of the above embodiments, two pipes 12 are connected to the joint block 10. However, it is possible to connect only one pipe to the joint block. Furthermore, it is possible to connect more than two pipes to the joint block.

Additional advantages and modifications will readily occur to those skilled in the art. The invention in its broader terms is therefore, not limited to the specific details, representative apparatus, and illustrative examples shown and described.

What is claimed is:

1. A pipe joint assembly comprising:
at least one pipe, each of which includes a radial projection that projects radially outwardly; and
a joint block, which has a hardness greater than that of the at least one pipe and includes:
a flow passage, which extends in the joint block;
at least one pipe-receiving opening, each of which is communicated with the flow passage and receives a corresponding one of the at least one pipe;
at least one crimpable segment, each of which is integrally formed in the joint block at a corresponding one of the at least one pipe-receiving opening and is crimpable over the radial projection of the corresponding pipe to secure the corresponding pipe relative to the joint block when the corresponding pipe is received in the corresponding pipe-receiving opening; and
at least one pipe-engaging surface, each of which is positioned adjacent to a corresponding one of the at least one pipe-receiving opening and is engageable with the radial projection of a corresponding one of the at least one pipe, wherein each of the at least one pipe-engaging surface includes at least one of:
at least one engaging recess, each of which is engageable with the radial projection of the corresponding pipe to deform and receive a corresponding opposed portion of the radial projection of the corresponding pipe to interlock with the corresponding opposed portion of the radial projection when the corresponding crimpable segment is crimped over the radial projection of the corresponding pipe; and
at least one engaging protrusion, each of which is engageable with the radial projection of the corresponding pipe to deform and bite into a corresponding opposed portion of the radial projection of the corresponding pipe to interlock with the corresponding opposed portion of the radial projection when the corresponding crimpable segment is crimped over the radial projection of the corresponding pipe.

2. A pipe joint assembly according to claim 1, further comprising at least one abutting surface, each of which is radially positioned between a corresponding one of the at least one pipe-receiving opening and a corresponding one of the at least one crimpable segment and is engageable with the radial projection of the corresponding pipe to position the corresponding pipe at a predetermined position relative to the joint block, wherein at least one of the crimpable segment and the abutting surface, which are provided at each corresponding pipe-receiving opening, includes a corresponding one of the at least one pipe-engaging surface.

3. A pipe joint assembly according to claim 2, wherein:
each crimpable segment is an annular claw, which circumferentially extends around the corresponding pipe-receiving opening and projects outwardly generally in an axial direction of the corresponding pipe-receiving opening; and
the radial projection of each pipe is an annular flange, which circumferentially extends around the pipe.

4. A pipe joint assembly according to claim 3, wherein an inner circumferential surface of each annular claw includes a corresponding one of the at least one pipe-engaging surface, wherein each engaging recess of the annular claw extends in a direction generally parallel to the axial direction of the corresponding pipe-receiving opening.

5. A pipe joint assembly according to claim 4, wherein each engaging recess of the annular claw has a V-shaped cross-section.

6. A pipe joint assembly according to claim 4, wherein the at least one engaging recess of the annular claw includes a plurality of engaging recesses, which are circumferentially arranged at predetermined intervals.

7. A pipe joint assembly according to claim 3, wherein an inner circumferential surface of each annular claw includes a corresponding one of the at least one pipe-engaging surface, wherein each engaging recess of the annular claw has a polygonal shape.

8. A pipe joint assembly according to claim 7, wherein the polygonal shape of each engaging recess of the annular claw includes a rectangular shape.

9. A pipe joint assembly according to claim 3, wherein an inner circumferential surface of each annular claw includes a corresponding one of the at least one pipe-engaging surface, wherein the at least one engaging recess of the annular claw includes a helical engaging recess, which extends helically.

10. A pipe joint assembly according to claim 3, wherein each abutting surface of the joint block has an annular shape that corresponds to the annular flange of the corresponding pipe and includes a corresponding one of the at least one pipe-engaging surface, wherein the at least one engaging recess of the abutting surface includes a plurality of engaging recesses, which are circumferentially arranged at predetermined intervals.

11. A pipe joint assembly according to claim 1, wherein an outer surface of the radial projection of each pipe is substantially smooth.

12. A pipe joint assembly according to claim 1, wherein each crimpable segment includes a step, about which the crimpable segment is bent and is crimped over the radial projection of the corresponding pipe.

13. A pipe joint assembly according to claim 1, wherein each pipe is made of aluminum A3003, and the joint block is made of aluminum A6061.

14. A method for assembling a pipe joint assembly, which includes at least one pipe and a joint block, the method comprising:
inserting each pipe into a corresponding pipe-receiving opening of the joint block; and
crimping a crimpable segment of the joint block over a radial projection of the pipe such that at least one pipe-engaging surface of the joint block, each of which includes at least one of at least one engaging recess and at least one engaging protrusion, is engaged with the radial projection of the pipe, and thus the at least one of the at least one engaging recess and the at least one engaging protrusion of each of the at least one pipe-engaging surface deforms and interlocks with a corresponding opposed portion of the radial projection of the pipe.

15. A method according to claim 14, wherein:
the inserting of the pipe into the pipe-receiving opening of the joint block includes inserting the pipe into the pipe-receiving opening of the joint block until the radial projection of the pipe abuts against an abutting surface of the joint block; and
at least one of the crimpable segment and the abutting surface of the joint block includes a corresponding one of the at least one pipe-engaging surface.

16. A method according to claim 15, wherein an inner circumferential surface of the crimpable segment includes the corresponding one of the at least one pipe-engaging surface, wherein each engaging recess of the crimpable segment extends in a direction generally parallel to an axial direction of the corresponding pipe-receiving opening.

17. A method according to claim 16, wherein each engaging recess of the crimpable segment has a V-shaped cross-section.

18. A method according to claim 16, wherein the at least one engaging recess of the crimpable segment includes a plurality of engaging recesses, which are circumferentially arranged at predetermined intervals.

19. A method according to claim 14, wherein the crimping of the crimpable segment of the joint block includes bending of the crimpable segment about a step of the crimpable segment.
